(19) United States
(12) Patent Application Publication
(10) Pub. No.: US 2009/0168440 A1
(43) Pub. Date: Jul. 2, 2009

(54) Motorcycle perimeter lighting panel

(76) Inventor: Samuel E. Croft, Wheeling, WV (US)

Correspondence Address: Leslie K. Alderman, 67160 Airport Rd., St. Clairsville, OH, 43950, US

(21) Appl. No.: 12/317,041

(22) Filed: Dec. 18, 2008

Related U.S. Application Data
(60) Provisional application No. 61/008,134, filed on Dec. 19, 2007.

(51) Int. Cl. B62J 6/00

(52) U.S. Cl. 362/473

(57) ABSTRACT

A lighting panel designed to be affixed to the side luggage rack or trim rails on certain motorcycles equipped with such. This lighting panel consists of an enclosure designed and manufactured specifically containing the panel mount engagement interface relief and panel mount backing plate, designed with the dimension specifics required of being be attached to the side luggage rack or trim rails of certain motorcycles. The lighting panel may contain illuminating devices (light bulbs or LEDs) providing illumination when either self powered, or connected to the motorcycle electrical system. The illumination is projected through the removable panel faceplate, in which may be cutouts or apertures in the form of script, letters, numbers, graphics, designs, or artistic renderings. The panel faceplate is attached in such manner as to be easily removed and exchanged with other faceplates manufactured to fit this specific panel body. The ability to easily change the panel faceplate offers the motorcycle rider an opportunity to display and interchange various messages, graphics, or information as desired without the need to have to change the entire panel unit. Additionally, the unit itself may be used, devoid of an installed illumination system, simply as a sign or message board displaying a non-illuminated sign or message affixed to the motorcycle.

### BACKGROUND OF THE INVENTION

1. Field of the Invention

This invention relates generally to an illuminated lighting panel attached to the side of a motorcycle and incorporating a changeable faceplate containing script, pictures, or writing, visible when illuminated by activation of the contained illuminating devices within the lighting panel.

2. Prior Art

In the last decade or so, motorcycles have become an ever increasingly accepted and utilized mode of transportation, as well as an ever-growing segment of the recreational motor-sports industry. Consequently, there is increased awareness and visibility of motorcycles in general as their numbers increase. There are more varieties, styles, and types of motorcycles than ever. As they become more integrated into the culture and lifestyle, they are becoming an ever increasingly intrinsic part of various social gatherings and events. Some of these events are specific to the motorcycle lifestyle itself, while other events are ancillary to the specific lifestyle, but attended by those owning and riding bikes. As with any activity, often those participants will use their vehicle (bike, car, truck, SUV, ATV) as a rolling message board attaching a bumper sticker, window sign, flag, or banner, offering a message of some sort. Due to their limited size and the reduced surface area, motorcycles provide a minimal display are on which to place much of a message. While no one is expecting to be able to transform any vehicle into a rolling billboard, certain motorcycle riders would like a more noticeably visible, easier to read way to offer some kind of visual message attached to their bike. In addition, an ability to easily and quickly change the displayed message would offer more available and accessible message universality. This was one of the two design tenants intrinsic in the design goal of this particular lighting panel for which I am seeking patent protection.

Numerous prior art examples of illuminated signs themselves exist in a multitude of variations reflecting different approaches to housings, illumination sources, electrical components, circuitry, face panels, construction, mounting methods, and display variations. While they offer a wide variety of options, none are intended specifically to be affixed to a motorcycle. U.S. Pat. No. 5,105,568 is an example of a typical illuminated sign utilizing a housing, electric illumination, and a faceplate presenting the message, in this case “EXIT”. Numerous prior art examples similar to this particular example exist, but detailed analysis or discussion of them serves little purpose beyond general interest.

In addition to the standard lighting that is legally required of all street legal motorcycles, there is a wide variety of additional lights and lighted accessories available as add-on dress up items. In U.S. Pat. No. 5,727,864 the invention embodiment is a support assembly for attaching two additional lights on either side of the forward-facing stock motorcycle headlight. This provides additional lighting in front of the motorcycle as well as an aesthetic enhancement of the factory designed stock lighting set-up.

In U.S. Pat. No. 5,406,465 the invention is a set of light bars that are affixed to the lower portion of the motorcycle luggage carriers by means of attachment to a set of rails affixed for the purpose. These provide ancillary, dress-up accent lighting at a point on the bike not normally lighted.

In U.S. Pat. No. 3,788,532, the invention embodiment is a two-piece luggage case affixed to the rear of the motorcycle. As claimed in Claim no. 7 of this patent, a part of the lower portion of the invention embodiment case is affixed with tail lights, turn signal lights, and a safety reflector.

In U.S. Pat. No. D374,295, the invention embodiment is a light bar designed to be attached to a motorcycle cargo carrier rail set on those motorcycles equipped with such. Additionally, U.S. Pat. No. D370,284 is a similar light bar in function and attachment, but designed as a “wrap around” unit as opposed to the single plane design of the panel as depicted and patented in U.S. Pat. No. D374,295. Additionally, U.S. Pat. No. D277,799 embodies a very similar design as the three aforementioned patented embodiments, but incorporates differences commensurate with the individual nuances required of patent issuance. While these designs provide an ancillary lighting source at the rear and side of the motorcycle, they offer no means of providing an illuminated sign or message in either design or embodiment manifestation.

U.S. Pat. No. 1,887,087 shows an embodiment of a license plate holder with illuminated signal light. While specified within the patent text as intended to be affixed to an automobile, nothing would preclude adaptation to a motorcycle. Inclusion of the lighted “STOP” area at the top of the panel indicates it is intended to be mounted at the rear of the vehicle. While this is an illuminated message, it has no ability to be changed or altered, and is an intrinsic part of the holder itself with no provision to remove or replace the message as may be desired.

U.S. Pat. No. 6,478,458 shows an invention embodiment of a motorcycle license plate holder incorporating an illuminated message bar. While this particular invention embodiment provides for an interchangeable message bar or display, it is limited in scope and visibility by virtue of the patented design directive and intent that it be a motorcycle license plate holder. Inherent limitation as to peripheral side visibility of the affixed message bar are resultant of this embodiments design function of displaying a license plate, thus requiring that it face rearward. This negates any ability to position the holder and its included message bar in a position of visibility other than from directly behind. Additional limitations to the size and consequent visibility of the message bar are a function of the significantly reduced size of a motorcycle license plate and thus, the specific enclosure designed relative to this size and application while intended to specifically house such.

Additional objectives and advantages of the invention will become apparent to all from a consideration of the drawings and ensuing descriptions contained herein.

### BRIEF DESCRIPTION OF THE SEVERAL DRAWING VIEWS

1: panel faceplate. Serves as the removable cover of the perimeter lighting panel. It provides for a wide variety of multiplicitas cut-out renderings in the form of letters, numbers, slogans, verbiage, or artwork. The ability to easily exchange this faceplate provides the user an option of affixing different messages or renderings as may be desired.

2: lighting panel body. The unit body, produced in such manner as to provide a cavity in which electrical lighting components may be installed as required of providing the back-lighting needed for illumination of the panel faceplate cut-out(s).

3: rear body mounting plate. This backing plate serves to help attach the lighting panel body to the motorcycle luggage rack frame rails. When attached to the lighting panel body and tightened against the aforementioned frame rails by means of threaded mounting bolts, it tightens the panel mount engagement interface relief(s) (see FIG. 4) directly against the frame rails, thus securing the perimeter lighting panel in place.

4: panel mount engagement interface relief. The radiused cut-out on the back side of the lighting panel body. These relief's are cut to the radius dimension of the motorcycle luggage mount frame rails, thus providing the securing point interface against which the lighting panel body is tightened by installation of the rear body mounting plate.

5: panel body illumination cavity. The hollowed out area of the lighting panel body providing for placement of an illumination source.

6. panel face plate cut-outs. The cut-outs of the face plate that may be any form or manner of letters, numbers, text, artwork, or graphics that are highlighted by the illumination when activated

7. face plate mounting holes. The holes bored into the panel face plate through which the screws or bolts used to attach the face plate to the lighting panel body are inserted.

8. Face plate attachment bolt holes. The threaded bore holes placed in the lighting panel body into which the bolts or screws used to attach the face plate to the panel body are affixed.

9. Rear body mounting plate mount holes. The holes bored through the panel body through which the screws or bolts used to attach the rear body mounting plate are inserted.

10. Motorcycle frame rails. These are the luggage carrier frame rails attached on certain motorcycles, and provide the attachment point of the lighting panel body assembly.

*NOTE: These are NOT a part of the embodiment of the invention, but are included here as part of the drawings in order to provide the reference needed for explanation and visualization of the attachment method of the invention embodiment.

11. Threaded fasteners. A threaded fastener in the form of a bolt or screw, and of a length, diameter, and thread required of the application.

12. Threaded attachment bore. A bore, the inside of which is threaded in order to receive the threaded fasteners being inserted and tightened for the intended purpose.

13. Face plate mounting recess. A recess in the face of the lighting panel body sized commensurate with the face plate dimensions against which the panel face plate is attached.

FIG. 1. A frontal view of the lighting panel body (top) and the panel face plate (below) separated. Visible in the panel body is the cut-out illumination cavity and the attachment bore holes. The panel face plate depicts the mounting holes as well as the face plate cut-outs, shown here as octagon shaped cut outs. This depiction of the octagon shape of the cut-out is for illustration purposes only, and not intended to serve as a limitation of the particular cut-out shape or form that may be used on the panel face plate.

FIG. 2. Frontal view of the embodiment of the invention with the panel face plate mounted in position.

FIG. 3. Edge view of the invention embodiment with components separated.

FIG. 4. An end view of the invention embodiment with the components expanded and in their position relative to assembly of the embodiment. The frame rail(s) depicted are included for illustration purposes only and are NOT a part of the invention embodiment.

### DRAWING REFERENCE NUMERALS

1. panel faceplate
2. lighting panel body
3. rear body mounting plate
4. panel mount engagement interface relief
5. panel body illumination cavity
6. panel face plate cut-outs
7. face plate mounting holes
8. face plate attachment bore holes
9. rear body mounting plate mount holes
10. motorcycle frame rails
11. threaded fasteners
12. threaded attachment bores
13. face plate mounting recess

### DETAILED DESCRIPTION OF THE INVENTION/DRAWINGS

The similar reference characters denoted within the various drawings make reference to the same feature, part, or component irrespective of the perspective, view, or relative location of that feature, part or component. Use of specific terms, language, or descriptive narrative contained herewith is not intended to be construed as defined limitations of the invention embodiment, it's function, or applicability to it's intended purpose. The following narrative description of the drawings serves as a text explanation of the renderings only, and is not intended to place any inadvertent limitations regarding what is claimed.

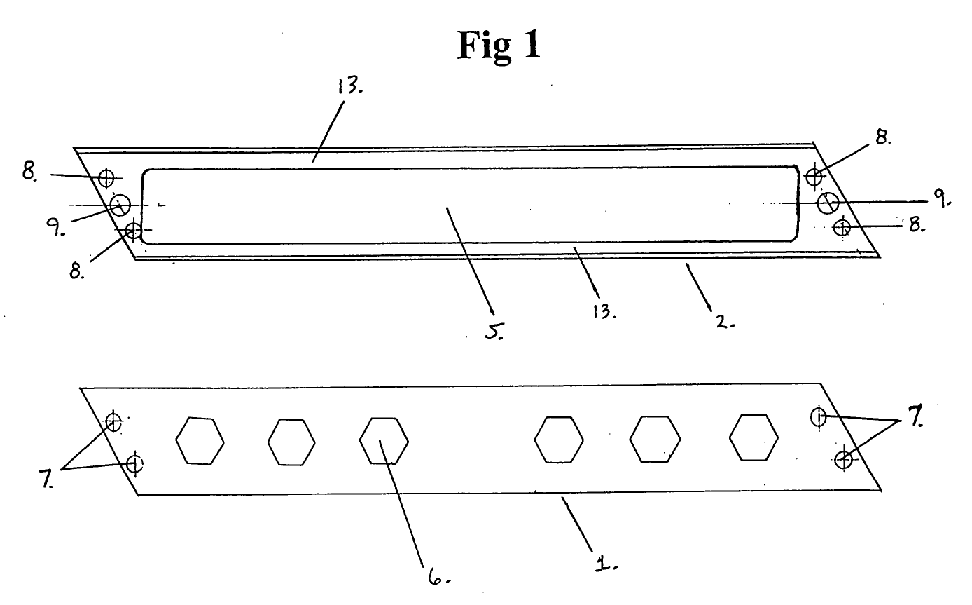

FIG. 1 shows the lighting panel body 2 with the panel faceplate 1. The panel body 2 is of a dimension in both length and width relative to the intended mounting area on the motorcycle for which it is to be affixed. The panel body 2 contains a cut-out, the panel body illumination cavity 5 in which may be placed or mounted illumination devices such as light bulbs or various LED type lighting assemblies. These illumination devices provide the back lighting illumination needed to highlight and make visible the panel face plate cut-outs 6 contained in the panel face plate 1. These panel face plate cut-outs 6 may be of any letters, numbers, text, art forms, graphics, or renderings. Additionally, the panel face plate 1 may be of a solid, transparent material such that any text messages or graphics may be applied to the surface, thereby rendering a visible presentation of said message without the need of the panel face plate cut-outs 6. The lighting panel body 2 contains a face plate mounting recess 13 of a length and width the same as of the panel faceplate, and of the depth the same as the thickness of the panel faceplate 1 so that when said panel faceplate 1 is attached to the lighting panel body 2 said faceplate is positioned flush with the horizontal edges of the panel body 2.

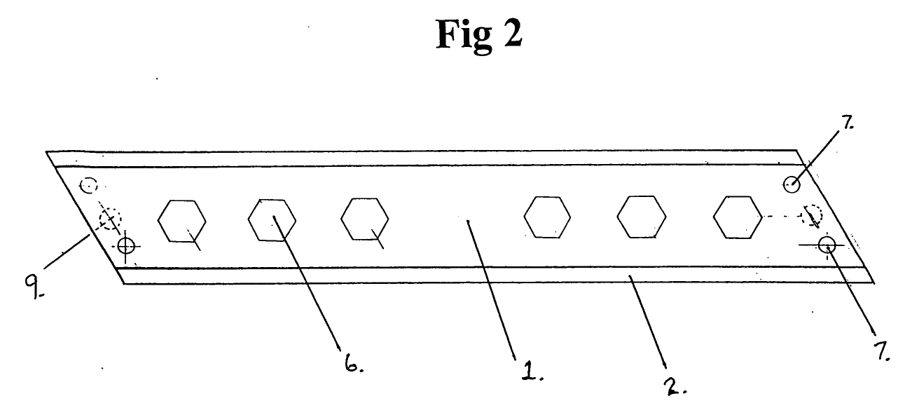

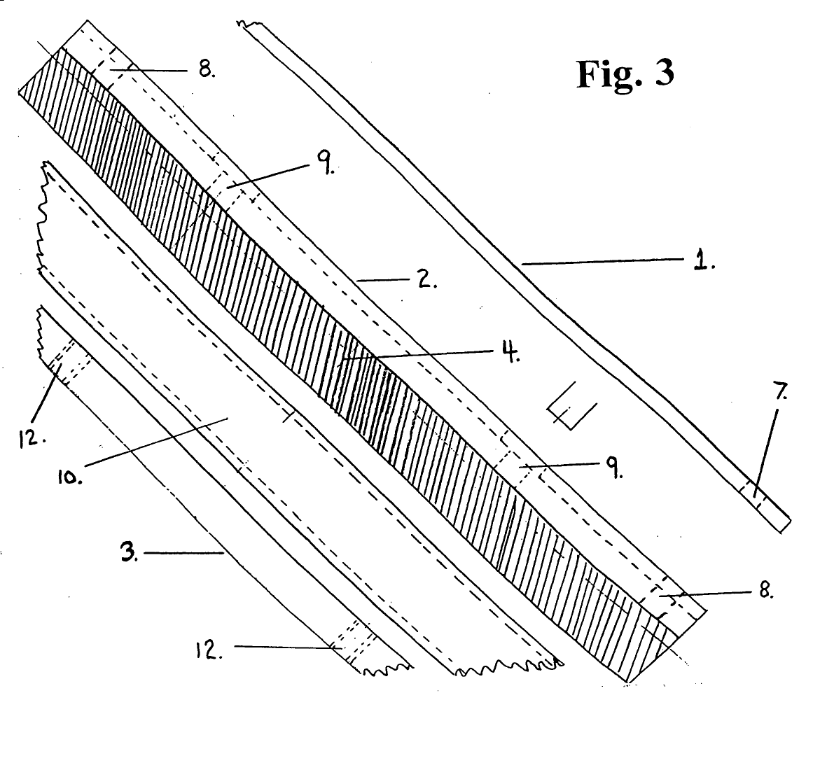

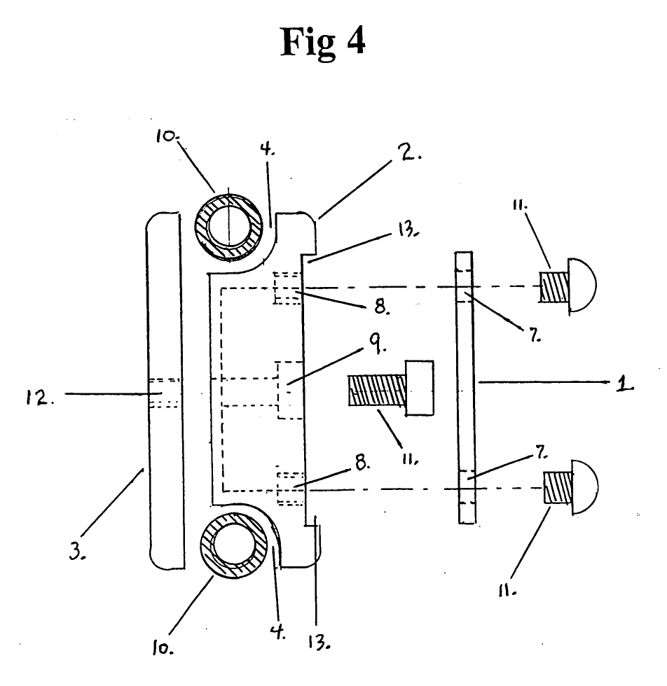

The panel faceplate 1 is attached to the lighting panel body 2 by use of threaded fasteners 11 extending through the face plate mounting holes 7 located at the outer ends of the panel faceplate 1. These threaded fasteners threadedly engage the face plate attachment bore holes 8 contained at the outer ends of the lighting panel body 2, which are located at a dimension providing alignment of the panel faceplate 1 with the lighting panel body 2 as depicted in FIG. 2. As depicted in FIG. 1, the lighting panel body 2 additionally has at each outer end a rear body mounting plate mount hole 9; a hole bored perpendicular to the lighting panel body 2 face for insertion of the threaded fasteners 11 in order to attach the rear body mounting plate 3 as depicted in FIG. 3 and FIG. 4.

These rear body mounting plate mount holes 9 are bored of a diameter such that they allow recess of the head of the threaded fasteners 11 thereby keeping the head of such fasteners flush with the surface area of the lighting panel body 2 against which the panel faceplate 1 will be positioned when placed into the face plate mounting recess 13.

The face plate mounting recess 13 is more clearly depicted in FIG. 4 which shows an end view of the complete embodiment of the invention. This is a relief or recessed area of the lighting panel body 2 sized relative to the size of the panel faceplate 1; cut parallel to the face of the lighting panel body 2 and at a depth of the same thickness dimension as the panel 18 faceplate 1.

FIG. 3 shows and edge view of the invention embodiment with the various components in position relative to their assembly relationship. Of particular note is the inclusion of the motorcycle frame rails 10. It is important to understand that their inclusion in both FIG. 3 and FIG. 4 is for the sake of clarifying the attachment method of the invention embodiment, and is in no way to be construed as an inclusion in, or an integral part of the invention or its attendant claims.

The edge view of the invention, as shown in FIG. 3 shows lighting panel body 2, on the back edge of which is depicted the panel mount engagement interface relief 4. This is a relief cut along the top and bottom edge of said lighting panel body 2. This relief is of a diameter and radius commensurate with the diameter and radius of the motorcycle frame rails 10 against which the lighting panel body 2 is placed when mounted to a motorcycle. When the panel body 2 is positioned against the motorcycle frame rails 10, the panel mount engagement interface relief 4 provides the surface to surface contact area between the two. Said relief is cut parallel to the edge of the lighting panel body, and hence, is in parallel to the motorcycle frame rails 10 to which it is designed to attach.

The lighting panel body 2 is held in position against the motorcycle frame rails 10 by attachment of the rear body mounting plate 3 to the lighting panel body 2 by insertion of the threaded fasteners 11 through the rear body mounting plate mount holes 9 bored into the lighting panel body 2. These threaded fasteners 11 engage the threaded attachment bores 12 located in the rear body mounting plate 3. Once the fasteners are tightened, they draw the rear body mounting plate 3 tightly against the lighting panel body 2, thus sandwiching the motorcycle frame rails 10 into position in the panel mount engagement interface relief 4 and between said rear body mounting plate 3 and the lighting panel body 2.

While there are no illumination devices depicted in the referenced drawings, it is understood that the panel mount illumination cavity 5 of the lighting panel body 2 is there for that specific purpose should the user desire to install and use an illumination source. It is not the intent of this filing to limit the type or manner of the illumination devices by depiction of such. Hence, no specific devices are shown. The invention provides a unique ability to offer the user an option of changing the panel faceplate 1 as the need or desire requires. Easy removal and attachment of the plate by use of the threaded fasteners 11 allows this. While the drawings depict a panel faceplate 1 containing cut outs 6, there is no inherent preclusion of the use of a solid plate made of transparent material, upon which a sign, lettering, or artwork may be placed and thus, display the intended message or artwork as a function of the contrast between said lettered artwork and the background illumination with the electrified activation of such. Any rigid material such as wood, plastic, Plexiglas, metal, or fiberglass would be applicable for the panel faceplate 1 as well. This illuminated lighting panel provides an added safety feature to the motorcycle by virtue of the additional lighting placed at the side of the motorcycle, in an area typically devoid of any illumination. The ability to attach the lighting panel body 2 to the motorcycle by affixing it to the motorcycle frame rails 10 by use of the rear body mounting plate 3 requires no modification, addition to, or functionally complex interaction with said motorcycle. Removal is simply the reverse of the attachment process.

In its most simple iteration, the invention embodiment is an enclosure, capable of having a lighting source installed internally, and attached to the side of a motorcycle; the easily attached and removed face plate of which acts as a sign or message board display, with an ability to be illuminated by lights contained within the embodiment enclosure should such be affixed.

I now claim:

1. An illuminated lighting panel comprising:
a housing body comprised of a structural material and containing an elongated opening cavity in which may be affixed an electrically illuminated light source and the attendant connection(s) required of providing the electrical power needed to illuminate such;
a panel faceplate of dimension commensurate with the housing body and containing apertures representing text, messages, or artwork that when affixed to the housing body form a front wall behind which a lighting source, when activated, projects illumination through the faceplate apertures;
a panel backing plate of a dimension commensurate with the application, the purpose of which is to provide an attachment interface when said backing plate is positioned behind the motorcycle structural members, on the front side of which the lighting panel housing body is placed and drawn in contact with when said backing plate and the housing body are drawn together by use of attachment fittings interfaced between the housing body and said panel backing plate.

2. the lighting panel housing body of claim 1, the backside of which contains a longitudinal relief recess parallel to the top and bottom edge of said housing body at a spacing between the relief cut-outs commensurate with the dimension between the motorcycle structural members and of a radius of the same dimension as the motorcycle structural members to which the housing body is affixed.

3. the lighting panel faceplate in claim 1, utilizing attachment hardware providing removable connectivity of said faceplate with the lighting panel body

4. the lighting panel faceplate of claim 3 produced of a solid, transparent or semi-transparent material on which lettering, graphics, or artwork may be imprinted or affixed

5. the housing body in claim 1 using a battery powered or self contained illumination source, devoid of the need for any external electrical connection or hookup

6. the housing body in claim 1 devoid of any installed illumination source
